(19) United States
(12) Patent Application Publication
(10) Pub. No.: US 2009/0319378 A1
(43) Pub. Date: Dec. 24, 2009

(54) CUSTOMIZED ADVERTISING CONTENT

(75) Inventors: ALEKSEY SINYAGIN, BOTHELL, WA (US); KEVIN RIEDY, SEATTLE, WA (US); VIKAS SINGH, ISSAQUAH, WA (US); HRISHIKESH M. BAL, REDMOND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/143,531

(22) Filed: Jun. 20, 2008

(51) Int. Cl. G06Q 30/00

(52) U.S. Cl. 705/14.73

(57) ABSTRACT

In this invention, systems and methods for providing customized advertising content are provided. A publisher or a content owner may generate an image of, for example, an advertising unit. More particularly, the image may be generated to coordinate with the publisher or content owner's webpage. The image is then published with the content of the advertisement. By providing code or script in the publisher's webpage, the publisher may then request the customized advertising content, so that the browser sends a request for the customized advertising content. Thus, when a user views the publisher's webpage, the customized advertising content is presented, which includes the advertising content and the generated image.

### BACKGROUND

Advertising on the internet has distinct advantages over other types of advertising, including cost efficiency, the ability to target users, real time performance monitoring, and the like. As a publisher or content owner, however, one has little control over the look and feel of advertisements presented on your webpage. Further, if the publisher is able to create or modify an advertisement, very few options exist in designing the advertising content.

### SUMMARY

In accordance with embodiments of the present invention, systems and methods for providing customized advertising content are provided. A publisher or a content owner may generate an image of, for example, an advertising unit. More particularly, the image may be generated to coordinate with the publisher or content owner's webpage. The image is then published with the content of the advertisement. By providing code or script in the publisher's webpage, the publisher may then request the customized advertising content, so that the browser sends a request for the customized advertising content. Thus, when a user views the publisher's webpage, the customized advertising content is presented, which includes the advertising content and the generated image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing embodiments of the present invention;

FIG. 2 is a block diagram illustrating an overview of a system in accordance with an embodiment of the invention;

FIG. 3 is a diagram illustrating a system for providing customized advertising content, in accordance with an embodiment of the invention; and

FIG. 4 is a flow diagram illustrating a method in accordance with an embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In accordance with embodiments of the present invention, systems and methods for are provided. A publisher or a content owner may generate an image of, for example, an advertising unit. More particularly, the image may be generated to coordinate with the publisher or content owner's webpage. The image is then published with the content of the advertisement. By providing code or script in the publisher's webpage, the publisher may then request the customized advertising content, so that the browser sends a request for the customized advertising content. Thus, when a user views the publisher's webpage, the customized advertising content is presented, which includes the advertising content and the generated image.

In accordance with one embodiment of the present invention, one or more computer storage medium with computer-executable instructions embodied thereon for performing a method for providing customized advertising content is provided. The method comprises, in part, providing an interface to a publisher; receiving advertising content; generating an image associated with the advertising content; and providing the image and advertising content for presentation on a webpage, where the webpage includes a script provided by the publisher associated with the advertising content.

In another embodiment of the present invention, a computer system for providing customized advertising units is provided. More specifically, the computer system comprises, in part, a receiving component configured to receive advertising content; an image generating component configured to generate an image associated with the advertising content; and a publishing component configured to publish the image and advertising content as a customized advertising unit.

In yet another embodiment in accordance with the present invention, one or more computer storage medium with computer-executable instructions embodied thereon for performing a method for providing customized advertising content is provided. The method comprises, in part, providing an interface to a publisher; receiving advertising content; generating an image associated with the advertising content; inserting a script in the webpage associated with the generated image; publishing an advertising unit using the generated image and the advertising content; and providing the advertising unit for presentation on a webpage using the inserted script.

Having briefly described an overview of embodiments of the present invention, an exemplary operating environment suitable for use in implementing embodiments of the present invention is described below.

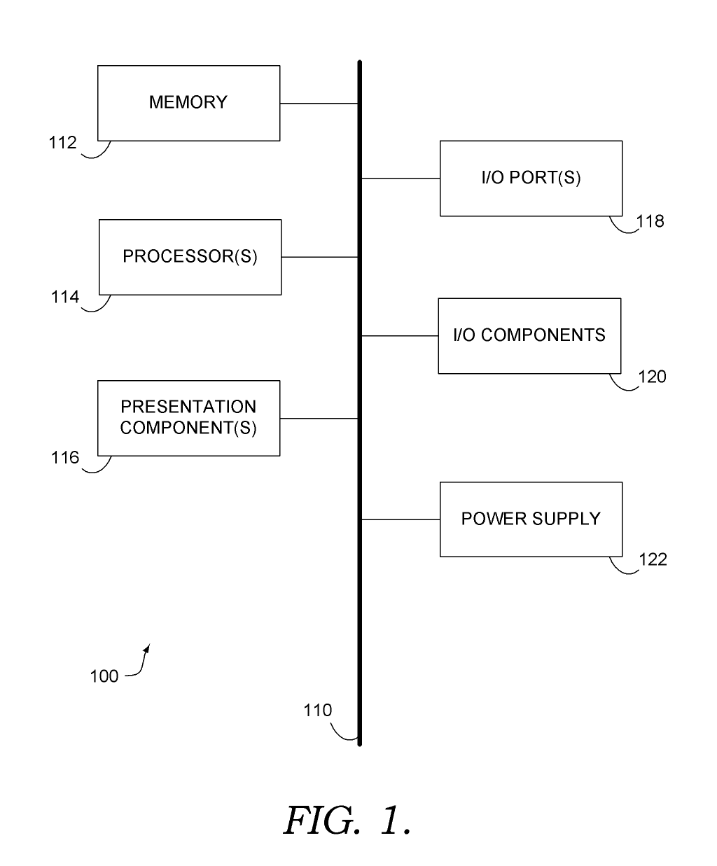

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

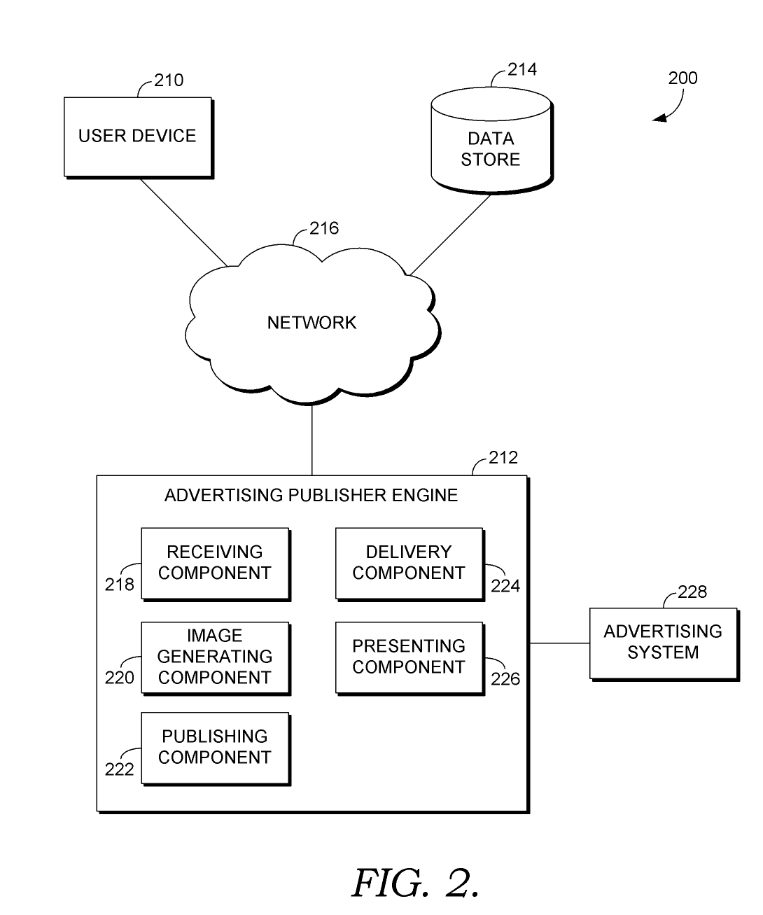

Turning now to FIG. 2, a block diagram is illustrated that shows an exemplary computing system 200 configured to provide customized advertising content, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated therein.

Computing system 200 includes an advertising publisher engine 212, a user device 210, and a data store 214 all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with various types of content, as more fully described below. It will be understood and appreciated by those of ordinary skill in the art that the information stored in the data store 214 may be configurable and may include any information relevant to online content. Further, though illustrated as a single, independent component, data store 214 may, in fact, be a plurality of data stores, for instance, a database cluster, portions of which may reside on a computing device associated with the advertising publisher engine 212, the user device 210, another external computing device (not shown), and/or any combination thereof.

Each of the advertising publisher engine 212 and the user device 210 shown in FIG. 2 may be any type of computing device, such as, for example, computing device 100 described above with reference to FIG. 1. By way of example only and not limitation, the advertising publisher engine 212 and/or the user device 210 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of the embodiments hereof.

As shown in FIG. 2, the advertising publisher engine 212 includes a receiving component 218, an image generating component 220, a publishing component 222, a delivery component 224, and a presenting component 226. In some embodiments, one or more of the illustrated components 218, 220, 222, 224, and 226 may be implemented as stand-alone applications. In other embodiments, one or more of the illustrated components 218, 220, 222, 224, and 226 may be integrated directly into the operating system of the advertising publisher engine 212 or the user device 210. In the instance of multiple servers, embodiments of the present invention contemplate providing a load balancer to federate incoming queries to the servers. It will be understood by those of ordinary skill in the art that the components 218, 220, 222, 224, and 226 illustrated in FIG. 2 are exemplary in nature and in number and should not be construed as limiting. Any number of components may be employed to achieve the desired functionality within the scope of the embodiments of the present invention. In some embodiments, the advertising publisher engine 212 further includes an advertising system 228. The advertising system 228, as the other illustrated components of the advertising publisher engine 212, may be implemented as a stand-alone application or may be integrated directly into the operating system of the advertising publisher engine 212.

The receiving component 218 is configured for receiving content associated with advertising content and receiving content associated with image generation. The advertising content and image generation content may be received from various data sources. More specifically, advertising content may be received from an advertising database, such as an advertising system. Image generation content may be received from, for example, a publisher of a webpage. Once received by the receiving component 218, the content may be stored, for instance, in association with data store 214, such that it is searchable to determine satisfaction of a user query, as more fully described below. Such received content may additionally be indexed, if desired.

The image generating component 220 is configured for generating an image that is capable of being associated with advertising content. One skilled in the art will appreciate that the image may be generated by various users. For example, in one embodiment, the publisher generates the image, and may generate an image that is visually similar to the publisher's webpage or application. Alternatively, the image may be generated, at least in part, by the advertiser. In a further embodiment, the publisher may generate the image, while the advertiser is capable of limiting, reviewing, etc. the generated image.

In generating an image, one skilled in the art will appreciate that many aspects of the image may be created or modified. For example, the publisher may determine the outline, background, pattern, font, effect, transitions, etc. of the advertisement.

The publishing component 222 is configured to publish the content that has been received and/or generated. For example, the publishing component 222 may publish advertising content that has been received that includes text, labels, etc., with an image that has been generated (e.g., from image generating component 220) that includes visual details of the ad. One skilled in the art will appreciate that any suitable method of publishing the multiple forms of content may be used.

The delivery component 224 is configured for delivering customized advertising content to, for example, a user interface appearing on a webpage. In embodiments of the present invention, a user's browser that is viewing the webpage may send a request to the delivery component 224 for the customized advertising unit, and the delivery component 224 streams the published advertising unit (e.g., published by the publishing component 222) back to the user.

The presenting component 226 is configured for presenting at least one customized advertising unit. Typically such presentation will be by way of display in associations with a user interface. However, other forms of presentation, including audio presentation and audio/video presentation, are contemplated to be within the scope of embodiments hereof.

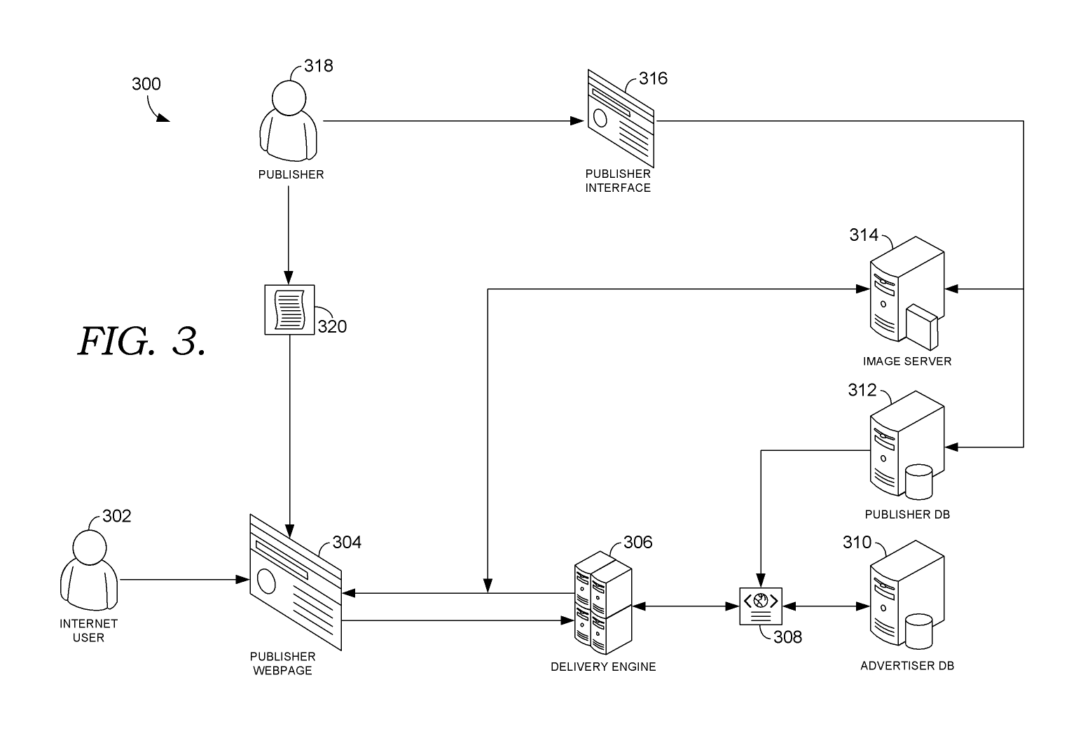

FIG. 3 illustrates an exemplary system 300 for providing a customized advertising unit. As shown in FIG. 3, a publisher, such as publisher 318, may include any content or application owner. For example, an entity that operates a webpage and owns the content of the webpage may be a publisher. A further example includes an owner of an application, where the application is capable of publishing advertising content. One skilled in the art, however, will appreciate that any type of content or application owner is comprehended as a publisher, in accordance with embodiments of the present invention.

An interface, such as interface 316, is presented to the publisher. Using interface 316, publisher 318 follows a process, which may include setting advertising unit parameters, visual appearance, etc. Based on the publisher's input, an image (e.g., a background image) is generated. Further, at this time, a code or script 320, such as a Javascript, is provided to publisher 318 to insert or paste on the publisher's webpage, as shown as 304.

In embodiments of the present invention, the generated image is stored on an image server or, alternatively, an image generation handler, shown as 314. At 310, an advertiser database is shown, which provides the advertising content for system 300. The advertiser database 310 may, for example, be part of an advertising system. However, one skilled in the art will appreciate that any type of advertiser database may be used with system 300.

The publisher database 312 serves to publish the generated image, thus giving it the look and feel of the customized advertising unit. With the publisher database 312 providing the generated image and the advertiser database 310 providing the advertising content, the combined customized advertising unit is created and is shown as the combined XML code at 308. The delivery engine 306 combines the generated image and advertising content and streams the customized advertising unit back to the client, publisher, content owner, etc.

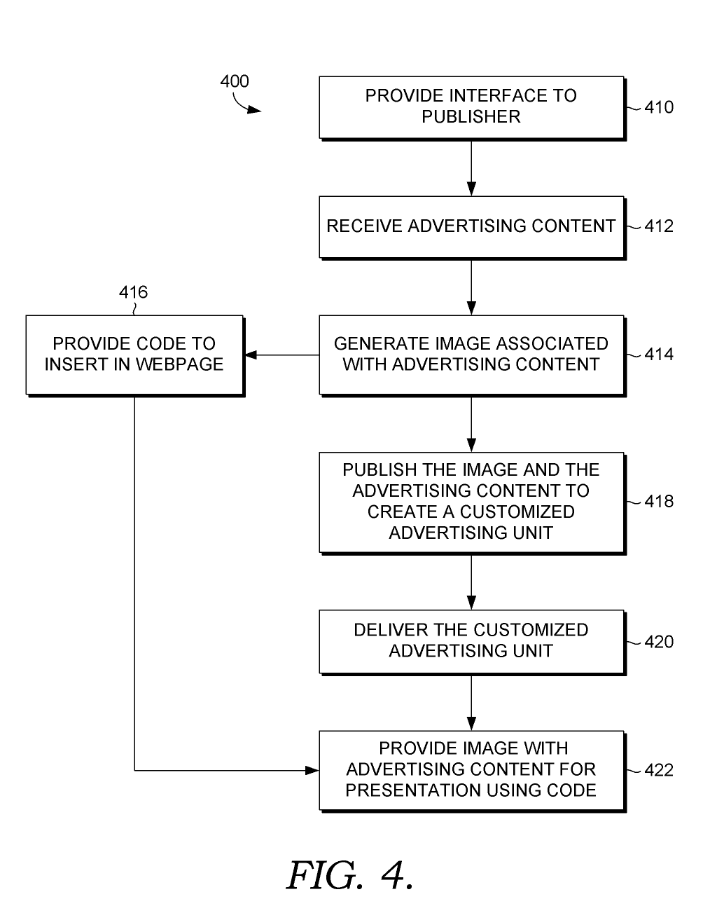

Turning now to FIG. 4, an exemplary method 400 for providing customized advertising content is illustrated. Initially, as indicated in block 410, the publisher or content owner is provided with an interface or any other suitable means for the publisher to modify or customize an advertising unit. As discussed above, a publisher, as referred herein, is intended to encompass any kind of content owner. By way of example, without limitation, a publisher may be a publisher of a webpage. Alternatively, a publisher may be a content owner, such as an application owner, with the capability of presenting advertisements over a network.

Next, at block 412, advertising content is received. One skilled in the art will appreciate that the advertising content may be received at any point in method 400. At block 414, an image is generated (e.g., utilizing the image generating component 216 of FIG. 2). In one embodiment of the present invention, the image is generated by the publisher. In such an embodiment, the publisher, as discussed above, may generate an image using the interface provided to the publisher, where the image is similar in appearance to the webpage or application of the publisher. In other embodiments, the advertiser may be able to restrict or limit the publisher's ability to generate the image. The generated image may be stored on an image server and associated with the advertising unit. Additionally, at this time, a code or script may be provided to the publisher to paste or insert on the webpage, application, etc. This is shown at block 416.

As indicated at block 418, the image and the advertising content are published to create the customized advertising unit (e.g., utilizing the publisher database 312 of FIG. 3). In embodiments of the invention, the publishing step occurs after, for example, a browser sends a request to a delivery engine (e.g., the delivery engine 306 of FIG. 3) for an advertisement based on the publisher's advertising unit. At block 420, the customized advertising unit is delivered to the publisher. At this point in method 400, the generated image may be cached in the browser for optimal performance and future use.

Next, using the inserted code on the webpage, the customized advertising unit is presented on the webpage, as shown at block 422. One skilled in the art will appreciate that because the majority of these steps occur on the server side, the publisher is freed from the task of maintaining any additional scripts, while still providing the user with rich and dynamic advertisements.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer storage medium with computer-executable instructions embodied thereon for performing a method for providing customized advertising content, the method comprising:
providing an interface to a publisher;
receiving advertising content;
generating an image associated with the advertising content; and
providing the image and advertising content for presentation on a webpage, wherein the webpage includes a script provided by the publisher associated with the advertising content.

2. The one or more computer storage medium of claim 1, wherein the advertising content is received from a source other than the publisher.

3. The one or more computer storage medium of claim 1, wherein the advertising content is received from an advertising system.

4. The one or more computer storage medium of claim 1, wherein providing the image and advertising content for presentation comprises publishing the image and advertising content into a customized advertising unit.

5. The one or more computer storage medium of claim 4, wherein providing the image and advertising content for presentation further comprises delivering the customized advertising unit to the webpage.

6. The one or more computer storage medium of claim 1, wherein the advertising content comprises a plurality of advertising content.

7. The one or more computer storage medium of claim 6, wherein at least one of the advertising unit is a banner ad.

8. A computer system for providing customized advertising units, the computer system comprising:
a receiving component configured to receive advertising content;
an image generating component configured to generate an image associated with the advertising content; and
a publishing component configured to publish the image and advertising content as a customized advertising unit.

9. The computer system of claim 8, further comprising an advertising system.

10. The computer system of claim 9, wherein the advertising system provides the advertising content.

11. The computer system of claim 9, further comprising a presenting component configured to provide a presentation of the customized advertising unit.

12. The computer system of claim 8, wherein the publishing component publishes a plurality of advertising content.

13. The computer system of claim 8, wherein at least one advertising unit is a banner ad.

14. The computer system of claim 8, wherein at least one advertising unit is a video ad.

15. One or more computer storage medium with computer-executable instructions embodied thereon for performing a method for providing customized advertising content, wherein the publisher has a webpage, the method comprising:
providing an interface to a publisher;
receiving advertising content;
generating an image associated with the advertising content;
inserting a script in the webpage associated with the generated image;
publishing an advertising unit using the generated image and the advertising content; and
providing the advertising unit for presentation on a webpage using the inserted script.

16. The one or more computer storage medium of claim 15, wherein the advertising content is received from a source other than the publisher.

17. The one or more computer storage medium of claim 15, wherein the advertising content is received from an advertising system.

18. The one or more computer storage medium of claim 15, wherein the advertising content comprises a plurality of advertising content.

19. The one or more computer storage medium of claim 15, wherein at least one advertising unit is a banner ad.

20. The one or more computer storage medium of claim 15, wherein at least one advertising unit is a video ad.
